(19) United States
(12) Patent Application Publication
(10) Pub. No.: US 2026/0052305 A1
(43) Pub. Date: Feb. 19, 2026

(54) REAL-TIME CAMERA-TO-CLOUD MEDIA TRANSFER AND AI-BASED ANALYSIS SYSTEM

(71) Applicants: Venkata Krishnan GANESAN, Jersey City, NJ (US); Anusha Sundararajan, Jersey City, NJ (US); Satyapalsinh Gohil, Jersey City, NJ (US)

(72) Inventors: Venkata Krishnan GANESAN, Jersey City, NJ (US); Anusha Sundararajan, Jersey City, NJ (US); Satyapalsinh Gohil, Jersey City, NJ (US)

(21) Appl. No.: 19/304,314

(22) Filed: Aug. 19, 2025

Related U.S. Application Data
(60) Provisional application No. 63/684,731, filed on Aug. 19, 2024.

(51) Int. Cl. H04N 23/60; G11B 27/34; H04L 67/06; H04N 5/77; H04N 5/91; H04N 23/62; H04N 23/66; H04W 84/12

(52) U.S. Cl. CPC H04N 23/64; H04L 67/06; H04N 5/77; H04N 5/91; H04N 23/62; H04N 23/66; G11B 27/34; H04W 84/12

(57) ABSTRACT

The invention provides a real-time media transfer and analysis system for DSLR cameras comprising a hardware device, a software application, and a cloud-based AI platform. The hardware module connects to DSLR cameras via USB or AV port and transfers captured media wirelessly to a secure cloud storage. The device features universal compatibility, long battery life, intelligent power management, and an intuitive mounting system. The mobile application enables device setup, transfer control, network configuration, and real-time monitoring. Uploaded images are subjected to AI-driven analysis in the cloud, where they are assessed for technical quality, categorized by content, and rated for aesthetic value. The system offers automatic sorting, metadata tagging, dynamic album creation, and sharing features. It includes encryption for secure transmission and storage, robust backup mechanisms, and supports offline queuing. Designed for professional photographers, the invention significantly enhances the efficiency and reliability of digital media workflows in field and studio environments.

### CROSS REFERENCE TO RELATED APPLICATIONS

This application claims priority to U.S. Provisional Patent Application No. 63/684,731, filed Aug. 19, 2024, which is incorporated by reference in its entirety.

### FIELD OF INVENTION

The present invention relates to the field of digital photography and wireless data transfer, and more specifically, to systems and methods for real-time transfer, storage, and AI-enhanced analysis of digital media captured using DSLR cameras.

### BACKGROUND OF THE INVENTION

The digital photography and videography industry has undergone significant technological advancements in recent years, particularly in camera technology and cloud computing, driven by the growing demand for better media quality, storage, and processing capabilities. Despite these advancements, a critical gap remains in the efficient transfer and management of digital media, particularly in professional and time-sensitive scenarios.

Professional photographers, photojournalists, videographers and even enthusiastic amateurs frequently encounter situations where rapid transfer of digital media and backup are crucial. Live events, breaking news coverage, remote shoots in challenging environments, and time-sensitive commercial projects all demand a seamless workflow from media capture to delivery. The current practice followed for the transfer and management of digital media involves a manual multi-step process: capturing images and videos on a DSLR camera, manually transferring these files to a computer or mobile device, and then uploading them to cloud storage or sending them to clients. This process is not only time-consuming but also introduces multiple points where the chances of human error are high.

Although there exist wireless transfer solutions available in the market to automate the manual transfer of digital media, they often suffer from the following drawbacks:
1. Real-time Capabilities: Many current solutions offer wireless transfer but lack true real-time functionality. There is often a significant delay between capture and recording of digital media and availability in cloud storage, which can be critical in fast-paced environments.
2. Universal Compatibility: Most wireless transfer systems are designed for specific camera models or brands, limiting their applicability and requiring photographers to use different solutions for different equipment.
3. Ease of Use: Setting up and managing wireless transfers can be complex, often requiring technical expertise that detracts from the photographer's primary focus.
4. Security: As digital media files often contain sensitive or valuable content, the security of wireless transfers is paramount. Many existing solutions do not provide robust, end-to-end encryption or secure authentication methods.
5. Intelligent Media Analysis: While cloud storage solutions have become more sophisticated, they typically lack integrated AI-based analysis tools. Photographers are left to manually sort through, rate, and categorize their images, audios and videos, a time-consuming process that delays delivery and reduces productivity.
6. Complex Setup and Operation: Some wireless transfer systems require complex configuration processes, creating a barrier to adoption and efficient use, especially for less technically inclined photographers
7. Durability and Reliability: Photography often occurs in challenging environments. Existing transfer solutions may not be designed to withstand the rigors of professional use in varied conditions.
8. Power Management: Long shooting sessions require solutions that are power-efficient and do not drain camera batteries, a consideration often overlooked in current wireless transfer systems.

International Patent Application Publication No. WO2024013732A1 to Zohar, et al., entitled “Device, system, and method for uploading photos from multiple digital cameras to a unified cloud-based account over dedicated cellular communication links,” discloses a Data Uploading Apparatus that connects to a standalone digital camera during an event and continuously transfers captured photographs to a cloud-based repository using a cellular network. The apparatus includes a hardware connector, internal non-volatile memory, a battery, and a processor that copies images in real time from the camera's memory. The prior art does not support a Wi-Fi network, unlike the present invention, and therefore may not be able to support large file transfers, which is commonplace in the photography industry. In contrast, the present invention incorporates a Wi-Fi module to enable efficient transfer of large files, as well as cellular network modules to ensure continued connectivity in situations where a reliable Wi-Fi network is unavailable. Furthermore, although the prior art makes a bare mention regarding the incorporation of Artificial Intelligence for the purpose of editing, discarding, and improving the images, it doesn't provide an analysis tool for the preliminary sorting and rating of digital media through parallel processing of three different types of screening, which is provided in the present invention.

Chinese Patent Application Publication No. CN210225460U to Wan, et al., entitled “Photo uploading device” discloses a photo uploading apparatus designed to enable automated, wireless transfer of image data from a camera to a cloud server. The apparatus comprises a camera unit, an embedded Wi-Fi module, an Internet of Things (IoT) module, an upload module, a cloud server, and a photo editing processing module. In the prior art, the Wi-Fi module must be present in the camera device itself, and therefore, it is not suitable for those DSLR cameras that do not support Wi-Fi directly. The present invention, however, acts as a Wi-Fi access point, thereby providing a universal solution for real-time transmission of digital media. Furthermore, the prior art doesn't provide an Artificial Intelligence-based analysis tool for the preliminary sorting and rating of digital media through parallel processing of three different types of screening, which is provided in the present invention.

While existing technologies attempt to address some of the aforementioned issues, they fall short of delivering a comprehensive and holistic solution that resolves all shortcomings through a single system. Therefore, there exists a need to provide a single system that can tackle all problems simultaneously.

### SUMMARY OF THE INVENTION

An object of the present invention is to provide a comprehensive solution for secure real-time wireless transfer of digital media from DSLR cameras to cloud storage.

Another object of the present invention is to enable broad compatibility across various DSLR camera models through a universal retrofit hardware design.

Yet another object of the present invention is to provide AI-powered functionality for preliminary sorting, rating, and quality assessment of digital media to enhance user productivity.

Further yet another object of the present invention is to ensure secure transmission and encrypted cloud storage of digital media to protect user content.

Further yet another object of the present invention is to provide remote configuration, monitoring, and control of the media transfer process via an intuitive mobile application.

Further yet another object of the present invention is to enhance the reliability and efficiency of media transfer workflows, particularly in time-sensitive or adverse environmental conditions.

Further yet another object of the present invention is to offer photographers an integrated hardware-software solution that replaces the manual system of transfer, sorting, and rating of digital media with an automated solution, resulting in a reduction of time consumption and human error.

Accordingly, in order to achieve the aforementioned objectives, the present invention provides a comprehensive system for real-time, secure, and intelligent transfer of digital media from DSLR cameras to cloud storage platforms.

The system comprises three integrated components:
(i) A rugged and retrofittable hardware device connected to the camera.
(ii) A feature-rich mobile application for user control and connectivity.
(iii) An AI-enabled cloud platform for storage, categorization, and analysis of media.

The hardware device supports USB/AV connectivity, includes high-speed Wi-Fi and Bluetooth modules, offers robust battery and power management features, and is designed to withstand harsh environmental conditions. The companion mobile application facilitates intuitive setup, wireless control, and cloud integration. The cloud platform provides automatic AI-based digital media rating, categorization, metadata tagging, and organization into dynamic albums, improving workflow efficiency for professional photographers.

### BRIEF DESCRIPTION OF THE DRAWINGS

FIG. 1 is a block diagram illustrating the interrelationship of the components in accordance with some embodiments

FIG. 2 is a block diagram illustrating the components of the hardware device

FIG. 3 is a block diagram illustrating the receipt of data in the cloud storage and the subsequent categorisation and rating by the AI analysis tool in accordance with some embodiments

FIG. 4 is a block diagram illustrating the flow of the process of initial setup and Wi-Fi connection establishment in accordance with some embodiments

FIG. 5 is a block diagram illustrating the flow of the data from the DSLR camera to the cloud storage in accordance with some embodiments

FIG. 6 is an assembly view of the hardware device on the DSLR camera module

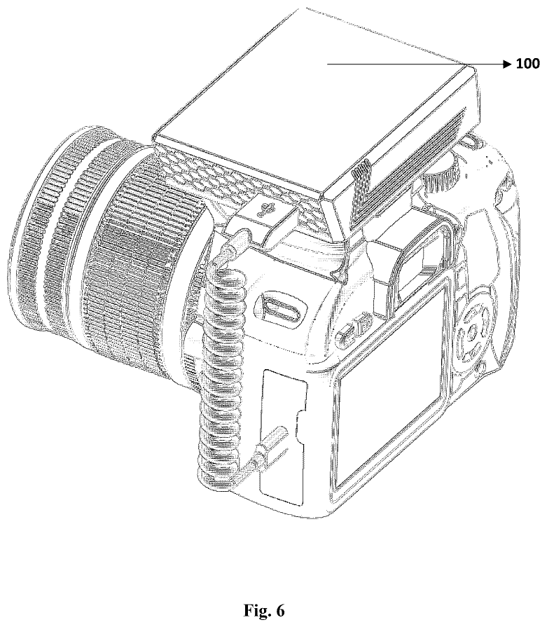

### DETAILED DESCRIPTION OF THE INVENTION WITH RESPECT TO THE DRAWINGS

### Key Definitions

DSLR: Digital Single-Lens Reflex
USB: Universal Serial Bus
Wi-Fi: Wireless Fidelity
AV: Audio/Visual
LPDDR4: Low Power Double Data Rate 4
eMMC: Embedded Multi-Media Card
CPU: Central Processing Unit
GPU: Graphics Processing Unit

The present invention, embodied as a Real-Time Camera-to-Cloud Media Transfer and AI-Based Analysis System, is described in detail below with reference to illustrative embodiments. The described embodiments are not intended to be exhaustive or to limit the invention to the precise forms disclosed. Rather, the invention may be embodied in various forms and modifications, and in functional equivalents, without departing from the spirit or essential attributes thereof. As used herein, the term ‘comprising’ and variations thereof are intended to be inclusive or open-ended, permitting the inclusion of additional elements or steps not expressly recited.

The present invention is a Real-time Camera to Cloud Media Transfer and Analysis System. The present system comprises three main components: a hardware device, a software application, and a cloud platform. The cloud platform further comprises an AI analysis tool that automatically rates and categorizes media automatically uploaded to the cloud. These components work in harmony to provide a seamless, efficient, and intelligent system for image, audio and video capture, transfer, storage, and analysis.

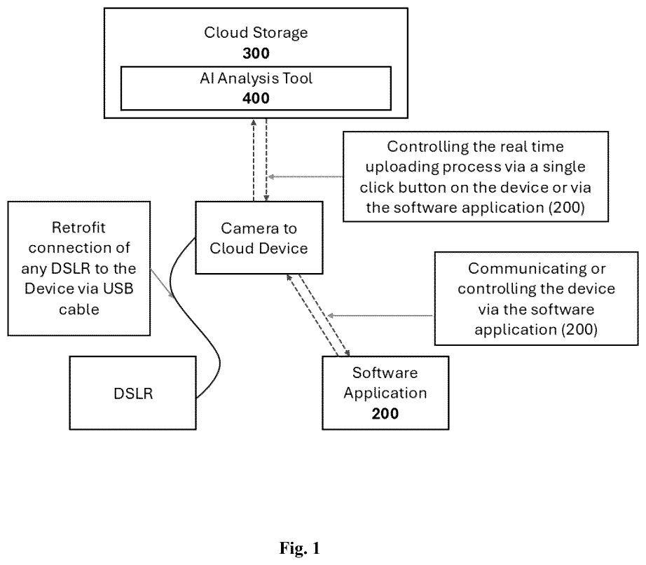

The interrelationship of the components in the present invention is shown in FIG. 1. The hardware device (100) of the present invention is connected to the DSLR camera via a USB cable utilizing the USB or AV port available in the camera. The software application (200) is a mobile application that controls the hardware device (100) and the transfer of the digital media to the cloud storage (300). Once the hardware device (100) is turned on and is connected to a secure Wi-Fi connection, it transfers the digital media to cloud storage (300) from the camera in real-time as the image is being captured or the audio or video is being recorded. The cloud storage (300) comprises an AI analysis tool (400) for the sorting and rating of the digital media.

In some embodiments of the present invention, the hardware device (100) is a device with retrofit compatibility to all DSLR cameras. The hardware device (100) has dimensions of approximately 300 mm×60 mm×20 mm, and weighs less than 350 grams, making it compact and lightweight, thereby not consuming space or adding significant bulk to the photographer's kit.

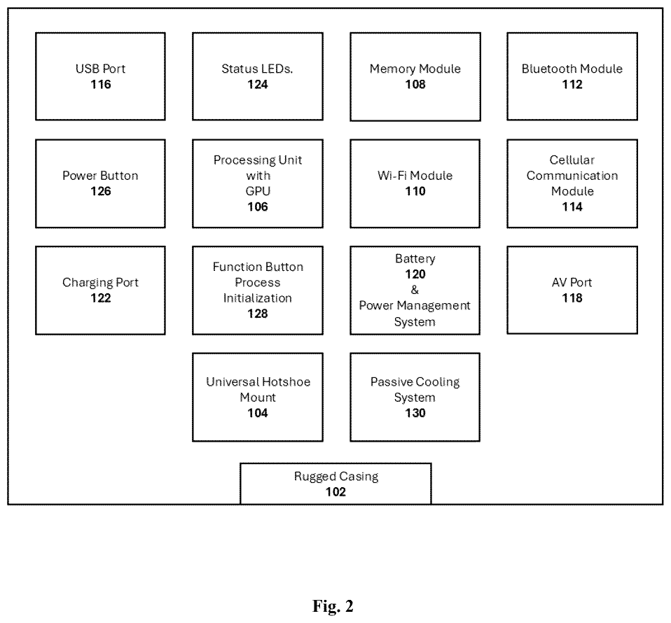

As shown in FIG. 2, the hardware device (100) comprises a casing (102), a universal hotshoe mount (104), a processing unit (CPU) (106), a memory module (108), a Wi-Fi module (110), a Bluetooth module (112), cellular communication module (114), a USB port (116), a AV port (118), a battery (120), a charging port (122), status LEDs (124), a power button (126), a function button (128), and a passive cooling system (130).

In some embodiments of the present invention, the casing (102) is constructed using high-impact, weather-resistant polycarbonate with a 1P67 rating, making it suitable for adverse environmental conditions and temperatures ranging from −20° C. to 50° C. The casing (102) also protects the internal components from dust and water damage. A universal hot shoe mount (104) is provided to affix the hardware device (100) to the hot shoe of the camera module or if a rig is being used, it can be secured to the rig via its mounting screw. The processing unit (106) is a high-performance, low-power CPU with a dedicated media processing unit for efficient handling of digital media data.

In some embodiments of the present invention, processing unit (106) comprises a Graphics Processing Unit (GPU) or AI accelerator enabling on-device execution of machine learning models for real-time media analysis, sorting, and curation without reliance on the AI analysis tool (400) in the cloud infrastructure. This allows photographers operating in low-connectivity environments to benefit from AI-assisted workflows immediately after capture. The on-device GPU supports inference acceleration for convolutional neural networks (CNNs) and transformer-based vision models, enabling rapid technical quality scoring, content tagging, and preliminary aesthetic assessment before upload. This approach also reduces the size of uploads by filtering low-quality or unwanted media before transfer, optimizing bandwidth usage, and accelerating delivery timelines.

The memory module (108) includes 1 GB of LPDDR4 RAM, which facilitates efficient multitasking, high-speed data access, and temporary buffering of intermediate processing data. The module incorporates 512 GB of embedded eMMC flash storage, that can be extended up to 2 TB configured to enable temporary storage of captured digital media data and system files during operation. Additionally, a microSD card slot is provided, which supports up to 512 GB of additional storage capacity which can function as a first backup for the captured media.

In some embodiments of the present invention, the Wi-Fi module (110) is a dual-band 802.11ac supporting 2.4 GHz and 5 GHz frequencies, providing a maximum theoretical speed of 867 Mbps for high-speed transfer of digital media. The Wi-Fi module (110) supports WPA3 encryption to ensure enhanced security of digital media data during transmission. Upon initial setup, the device generates a temporary Wi-Fi access point, facilitating a secure method for users to input their network credentials via the accompanying software application (200) The Bluetooth module (112), in the hardware device (100) helps in securing the initial connection with the cloud storage (300).

In some embodiments of the present invention, the hardware device further comprises an integrated 5G NR cellular communication module (114) supporting both sub-6 GHz and mm Wave bands. The cellular communication module (114) enables direct media transfer from the DSLR camera to the cloud platform in situations where intermediary Wi-Fi networks are not available, for example, in a remote shooting location or in environments with weak Wi-Fi coverage or reduced network reliability. The device automatically selects between available Wi-Fi and cellular connections based on link quality and cost settings configured by the user. A dual-SIM/eSIM configuration provides redundancy and the ability to use different carriers for improved coverage.

The USB port (116) is a USB 3.1 Gen 1 Type-C port that enables high-speed connectivity with DSLR cameras. It also supports USB On-The-Go (OTG) functionality, allowing direct interfacing with mobile devices when required. Furthermore, the USB interface is backward compatible with USB 2.0, ensuring seamless operation with older camera models. The AV port (118) is a 3.5 mm TRRS jack that supports composite video and stereo audio signals. This interface enables compatibility with cameras that utilize AV output for data transmission.

In some embodiments of the present invention, the battery (120) is a 5000 mAh lithium-polymer (Li-Po) rechargeable battery, capable of delivering up to 12 hours of continuous operation. It's hot-swappable design enables battery replacement without interrupting system functionality, ensuring seamless performance in field conditions. The charging port (122) is a USB-C charging port that supports USB Power Delivery (PD) of up to 18 W. It offers fast charging capabilities, allowing the battery to charge from 0% to 80% in approximately 45 minutes. Furthermore, the hardware device (100) supports pass-through charging, enabling the device to operate while simultaneously charging the battery. The hardware device (100) integrates intelligent power management circuitry that optimizes energy distribution across internal components to maximize efficiency. It includes low-power operational modes to extend battery life during periods of inactivity. For enhanced safety, the system is equipped with protection circuits against overcharging, over-discharging, and overheating.

The hardware device (100) comprises multi-colour status LEDs (124) that provide real-time visual indicators for power status, connectivity, and data transfer activity. It further includes physical control, comprising a power button (126) and a function button (128), enabling manual operation without reliance on the companion application. A passive cooling system (130), featuring internal heat spreaders, is integrated to maintain optimal operating temperatures without the need for active fan-based components.

The software application (200) of the present system is a mobile application that acts as the primary user interface for controlling the system. It is designed to be compatible with iOS and Android platforms, offering an intuitive and feature-rich experience.

The software application (200) comprises a wizard interface that provides a guided step-by-step setup process to assist first-time users with initial configuration. Additionally, the system supports firmware update management, enabling seamless updates to the operating software of the hardware device (100) for improved performance and security. The home screen of the software application (200) displays the device status, connectivity with both the camera module and the cloud storage (300), the progress of media transfers, and quick access to essential controls. The software application (200) provides a real-time status display of the camera connection, allowing users to monitor connectivity at a glance. When supported by the connected camera model, users can access an interface for adjusting camera settings. Additionally, a remote shutter control functionality is available for compatible cameras, enabling wireless capture directly from the device or companion application.

In some embodiments of the present invention, the software application (200) features Wi-Fi network management capabilities, allowing multiple network configurations. Additionally, the software application (200) provides a single touch start/stop function to control the automatic uploading of media from the DSLR camera to the cloud storage. It also offers batch upload capabilities, allowing users to select and transfer multiple existing images, audios and videos simultaneously. For time-sensitive tasks, the software application (200) includes priority queue management to ensure urgent files are uploaded ahead of others. The software application (200) further provides real-time progress bars for both individual file transfers and the overall upload process, offering users clear visibility into ongoing operations. A detailed transfer history log is maintained, featuring searchable and filterable entries for efficient tracking and record-keeping. Additionally, bandwidth usage monitoring and control options are provided, enabling users to manage network load and optimize performance based on available connectivity.

The software application (200) provides a cloud storage management interface that enables integration of the present invention with multiple cloud storage providers. Additionally, customs folders can be created and managed in the cloud storage through the user interface of the software application (200).

In some embodiments of the present invention, the software application (200) provides an AI analysis setting page that allows for adjusting the parameters of image quality assessment of the AI analysis tool, allowing users to have their image sorted and categorised based on the preferred level of sharpness, exposure, or composition. The software application (200) further provides threshold adjustment settings, allowing for automated culling of subpar images, streamlining post-capture workflows by filtering out low-quality or irrelevant content.

The software application (200) offers an image preview facility with zooming capabilities, enabling the user to have a quick view of the transferred media. Additionally, basic editing tools such as crop, rotate, and exposure adjustments are provided for enabling preliminary and urgent modifications. The software application (200) includes an EXIF data viewer that displays detailed metadata for each image. The software application (200) is equipped with customizable notification framework that alert users to key events, including transfer completions, errors, and AI analysis outcomes. It is integrated with mobile operating system notification services, ensuring real-time updates are delivered seamlessly through native channels such as push notifications and status banners

In the event that the Internet Connectivity is lost, the software application (200) automatically queues all the transfer tasks. Once the connection is restored, these transfers resume without requiring any manual intervention. In addition, the system includes comprehensive user account management features, offering secure login capabilities with the option for two-factor authentication to enhance account protection. Users can efficiently manage their subscriptions related to cloud storage and AI-powered features through an integrated interface. The system also provides access to detailed usage statistics and information on the current storage quota, allowing users to monitor and optimize their storage and service usage effectively.

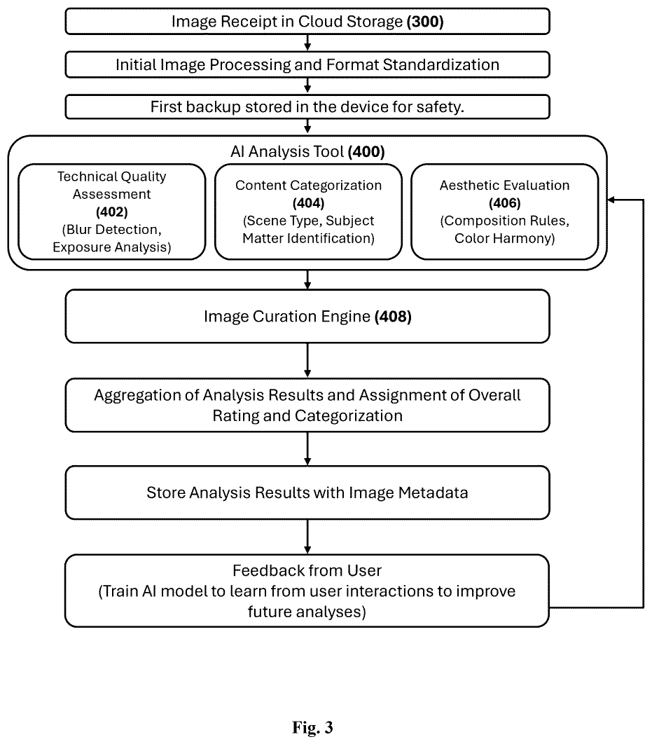

FIG. 3 illustrates the receipt of data in the cloud storage (300) and the subsequent categorisation and rating by the AI analysis tool (400). The present system is compatible with a multitude of cloud storage providers. The present system ensures secure storage of transmitted data using end-to-end encryption, preventing unauthorized access during transmission. For stored edia, the system uses AES-256 at-rest encryption. Additionally, regular security audits are conducted to identify and mitigate potential vulnerabilities, thereby ensuring compliance with major data protection regulations, such as the General Data Protection Regulation (GDPR) and the California Consumer Privacy Act (CCPA).

The cloud infrastructure is designed to efficiently manage high-volume uploads from multiple users simultaneously without performance degradation. To provide fast and responsive access to content across the globe, the system integrates with a Content Delivery Network (CDN), which reduces latency by delivering images, audios and videos from servers located closest to the user. Additionally, it employs adaptive bitrate streaming, which dynamically adjusts the quality of high-resolution images and videos based on the user's network conditions, ensuring smooth and efficient content delivery regardless of bandwidth fluctuations.

The AI analysis tool (400) automates the categorising and rating of the media uploaded in the cloud storage (300). The tool employs parallel processing to efficiently handle three different types of AI-driven media analysis, which includes technical quality assessment (402), content categorization (404), and aesthetic evaluation (406).

In technical quality assessment (402), the AI performs a multi-factor analysis that considers focus sharpness, exposure, colour balance, and noise levels. It can automatically detect common issues such as camera shake, motion blur, and chromatic aberration, while also allowing users to set custom quality thresholds based on their own standards. With respect to content categorization (404), the system leverages deep learning algorithms to recognize scenes such as landscapes, portraits, action shots, and wildlife, and applies object detection to enable content-based tagging. With user permission, it also includes facial recognition features to help organize photos based on the people in them. The aesthetic evaluation (406) generates composite scores by evaluating both the technical quality and predicted aesthetic appeal of each media. This rating algorithm adapts over time to reflect an individual photographer's unique style and preferences. It also incorporates metadata such as lens type and camera settings into its analysis to provide more nuanced and personalized ratings.

In some embodiments of the present invention, the AI analysis tool (400) comprises an image curation engine (408). The images resulting from parallel processing are delivered to the image curation engine (408) which automatically sequences and organizes images into narrative collections, highlight videos, or event-based galleries according to predefined or learned editorial preferences. The system can identify redundant shots, near-duplicates, and sequences, and retain only the most representative frames. Curation can be rule-based or AI-driven, adapting to the photographer's style over time.

The AI analysis tool (400) offers organization features that streamline image management through automation and AI. It automatically creates folders based on metadata such as shoot date and location, as well as recognized events or AI-determined content categories, making it easy to sort and retrieve files without manual effort. Additionally, it supports smart albums that update dynamically based on user-defined rules or the outcomes of AI-driven analysis, such as image quality, scene type, or subject matter. A robust tagging system enhances searchability by combining AI-generated tags with user-defined ones, enabling powerful and flexible sorting, filtering, and discovery across large photo libraries.

The present system also provides fine-grained access control and flexible sharing options. Shared content, including individual media or entire folders, may be configured with granular permission settings. Temporary access links may be generated for external collaborators or client previews, with expiration controls that enhance time-limited sharing security. For broader dissemination, the present system offers native integration with popular social media platforms, allowing for direct publication from within the interface.

To ensure data integrity and traceability, the present system includes built-in version control and backup mechanisms. Edits made to images are automatically versioned, allowing users to retrieve or revert to previous iterations while preserving the original file. Data redundancy is achieved through distributed storage across multiple geographic regions, enhancing fault tolerance. Additionally, configurable backup schedules may be established for synchronization with secondary cloud storage services.

The system is extensible through a RESTful API that facilitates integration with third-party image editing software, digital asset management (DAM) systems, and other workflow automation platforms. Webhook support is included to enable event-driven actions, such as initiating downstream tasks upon the completion of an media upload or AI analysis event.

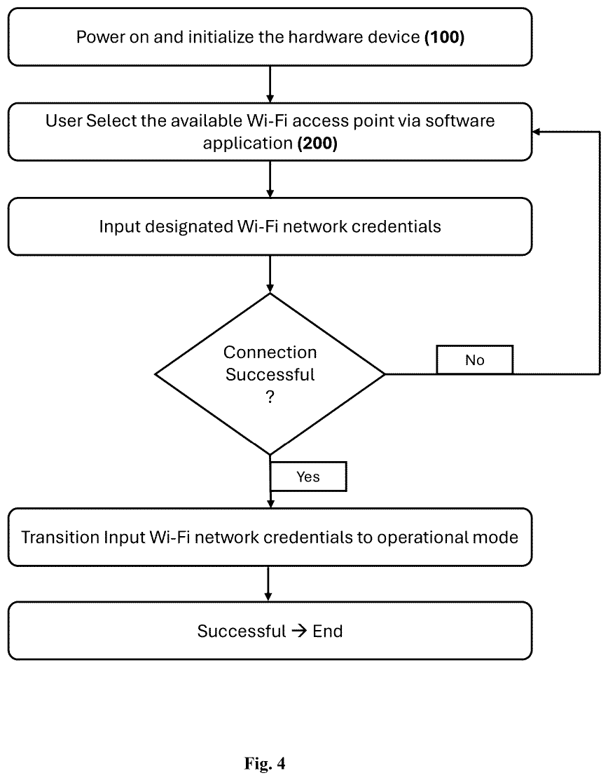

FIG. 4 illustrates the flow of the process of initial setup and Wi-Fi connection establishment. When the hardware device (100) is powered on for the first time, it enters the configuration mode. Upon initial setup, the hardware device (100) generates a temporary Wi-Fi access point, creating a secure Wi-Fi network with a unique SSID. The device receives Wi-Fi credentials through the secure setup channel. The user can enter the Wi-Fi network credentials through the software application (200). It then connects to the specified network using WPA2 or WPA3 encryption. The device performs a connection quality test, optimizing for the fastest available band. If the connection is successful, the hardware device (100) transitions to operational mode. If the connection is not successful, the hardware component remains a Wi-Fi access point, and the user is prompted to enter the valid network credentials.

The user connects their DSLR camera to the hardware device (100) using the USB port (116) or AV port (118). Upon connection, the device initiates a universal camera detection protocol that automatically identifies the make and model of the connected camera. Based on the identification, the device retrieves and loads the appropriate driver and communication protocol from its internal database to establish compatibility. A handshake process is then executed to confirm a successful connection and ensure the system is ready to initiate data transfer.

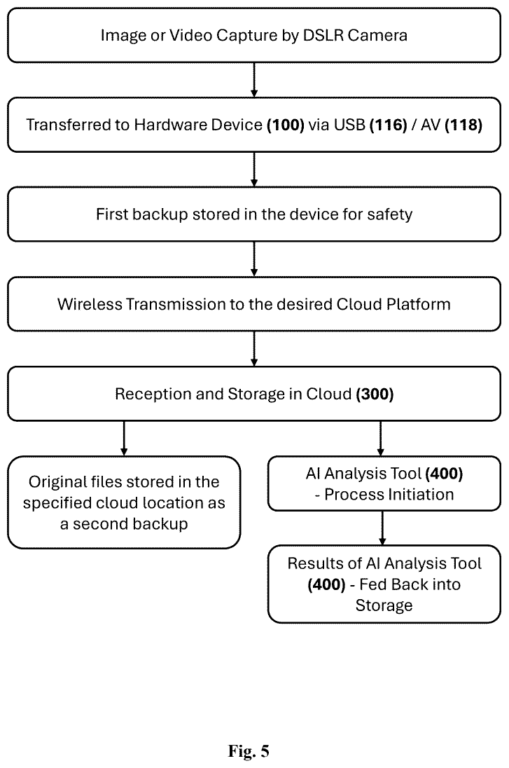

FIG. 5 illustrates the flow of the media from the DSLR camera to the cloud storage. The process of uploading the captured media can be initiated either by a start/stop button provided in the software application (200) or by using the function button (128) present on the hardware device (100). Once the image/video is captured by the camera, it is immediately transferred to the hardware device (100) through the USB/AV port. Upon detecting a newly captured media, the device rapidly transfers the file to its internal memory. The images are then sorted and analysed by the Graphics Processing Unit, in the hardware device (100). An immediate integrity check is performed to verify that the transfer is complete and free of corruption. Following successful validation, the device begins uploading the media to the designated cloud storage (300).

Simultaneously, if additional media are available, the device prepares the next file for transfer, ensuring uninterrupted processing. To manage this workflow efficiently, the device utilizes a proprietary queuing system that allows for seamless handling of multiple media in parallel. The While uploading the media to the cloud storage (300), a first backup is stored in the hardware device (100) to ensure easy retrieval in case of loss of data in the cloud or during transmission.

All data transferred from the camera to the hardware device undergoes an integrity check to ensure completeness and the absence of corruption. Prior to transmission to the cloud storage (300), each digital media is encrypted using AES-256 encryption, providing a high level of data security during transfer. Additionally, the device supports regular firmware updates, which are applied to address potential security vulnerabilities and to maintain compliance with evolving data protection standards.

In the event of a sudden network breakdown or a loss of internet connectivity, the hardware device (100) automatically terminates the uploading process and queues the transfer tasks. Once the network is regained or the connection is secured, the device continues the upload from the point where it stopped.

Once the files are uploaded in the cloud storage (300), the original files are stored in the specified cloud location as a specific backup. A copy of the image files is fed into the AI analysis tool (400), which performs categorization and rating of the image using parallel processing. The analysis is conducted across three distinct types of evaluation: technical quality assessment (402), which examines factors such as sharpness, exposure, and noise; content categorization (404), which identifies scene types and subject matter; and aesthetic evaluation (406), which assesses visual composition and colour harmony to determine predicted aesthetic appeal. The resulting images from the parallel processing is delivered to the image curation engine (408), which automatically organize processed images into structured outputs, eliminating redundancies.

Upon completion of the analysis, by the AI analysis tool (400), the results from the analyses are aggregated, and the images are rated and categorised based on such results. The images are then stored in the appropriate folders along with the analysis results as metadata.

What is claimed is:

1. A system for real-time transfer and analysis of digital media captured by a digital single-lens reflex (DSLR) camera, comprising:
a hardware device (100) retrofittable to DSLR cameras, the hardware device (100) including a processing unit (106) comprising a central processor and, a dedicated graphics processing unit or AI accelerator configured for on-device execution of machine learning models, a memory module (108) comprising random-access memory, embedded flash storage, and a microSD card slot, a wireless communication module comprising a Wi-Fi module (110) and a cellular communication module (114), a battery (120) with power management, a USB port (116), an AV port (118), and a casing (102) configured to withstand adverse environmental conditions;
a mobile software application (200) operatively coupled with the hardware device (100) and configured to control transfer of media to a cloud storage platform (300), provide a user interface for configuration, monitoring, and camera control, and manage media transfer workflows; and
the cloud storage platform (300) comprising an AI analysis tool (400) configured to perform parallel processing including technical quality assessment (402), content categorization (404), and aesthetic evaluation (406), and to automatically rate, sort, and organize the images into structured outputs.

2. A method for real-time transfer and analysis of media captured by a DSLR camera, the method comprising:
connecting a hardware device (100) to the DSLR camera through a USB port (116) or AV port (118);
detecting capture of a media and transferring the media to the hardware device (100);
performing an integrity check and encrypting the media;
transmitting the media using at least one of the Wi-Fi module (110) and the cellular communication module (114) to a cloud storage platform (300);
backing up the media in the memory module (108);
processing the image at the cloud storage platform (300) using the AI analysis tool (400) to conduct technical quality assessment (402), content categorization (404), and aesthetic evaluation (406) for sorting and rating the image;
processing the image at an image curation engine (408) of the AI analysis tool (400) to eliminate redundant images and generate curated galleries;
aggregating results from the AI analysis tool (400) and sorting and rating the images based on the results; and
storing the media in appropriate folders along with the analyzed results from the AI analysis tool (400) as metadata.

3. A non-transitory computer-readable medium storing instructions that, when executed by a processor, cause the processor to: receive digital media data from a DSLR camera via the hardware device (100), encrypt and transmit the data to the cloud storage platform (300), back up the data in the memory module (108), and analyze the data using the AI analysis tool (400) including the technical quality assessment (402), the content categorization (404), and the aesthetic evaluation (406), to automatically sort and rate the images.

4. The system of claim 1, wherein the casing (102) comprises high-impact polycarbonate with an IP67 rating, suitable for operation between −20° C. and 50° C.

5. The system of claim 1, wherein the hardware device (100) further comprises: a universal hot shoe mount (104), a passive cooling system (130), multi-color status LEDs (124), a power button (126), and a function button (128).

6. The system of claim 1, wherein the Wi-Fi module (110) is a dual-band 2.4 GHz/5 GHz module supporting WPA3 encryption, and the cellular communication module (114) supports both sub-6 GHz and mmWave frequency bands.

7. The system of claim 1, wherein the USB port (116) is a USB 3.1 Gen 1 Type-C port supporting On-The-Go (OTG) functionality and backward compatibility with USB 2.0.

8. The system of claim 1, wherein the battery (120) is a 5000 mAh lithium-polymer battery providing up to 12 hours of operation, and the charging port (122) supports USB Power Delivery (PD) of up to 18 W, supporting fast charging, and pass-through charging.

9. The system of claim 1, wherein the mobile software application (200) displays real-time camera connection, device status, progress bars, transfer history logs, and storage statistics.

10. The system of claim 1, wherein the mobile software application (200) provides: camera setting adjustment, remote shutter control, Wi-Fi network management, start/stop control of transfers, batch upload, priority queue management, and bandwidth monitoring and control.

11. The system of claim 1, wherein the mobile software application (200) further provides:
cloud storage management, creation of custom folders, an AI analysis settings page, threshold adjustments for automated culling, an image preview facility, basic editing tools, an EXIF metadata viewer, and customizable notifications.

12. The method of claim 2, further comprising queuing media transfer tasks during a network outage and resuming transmission when connectivity is restored.

13. The method of claim 2, wherein encrypting comprises applying AES-256 encryption during transfer and storing media with AES-256 encryption at rest.

14. The cloud storage platform (300) of claim 1, wherein the platform is compatible with multiple third-party cloud storage providers.

15. The AI analysis tool (400) of claim 1, wherein the tool further comprises an image curation engine (408) to eliminate redundant images and generate curated galleries.

16. The AI analysis tool (400) of claim 1, wherein the tool is configurable to operate in a rule-based mode or adaptively learn user preferences over time.

17. The AI analysis tool (400) of claim 1, wherein the tool further provides automatic folder creation, smart albums that update dynamically, and a tagging system to enhance image searchability.

18. The cloud storage platform (300) of claim 1, wherein the platform further provides granular permission settings, temporary access links, and integration with social media platforms.

19. The cloud storage platform (300) of claim 1, wherein the platform further comprises built-in version control with automatic backup of edited images.

20. The cloud storage platform (300) of claim 1, wherein the platform distributes stored media across multiple geographic regions to provide redundancy and fault tolerance.
